(19) United States
(12) Patent Application Publication
(10) Pub. No.: US 2025/0053788 A1
(43) Pub. Date: Feb. 13, 2025

(54) COMPUTING DEVICE, METHOD, AND SYSTEM FOR DETECTING WHETHER TARGET OBJECT IS ABNORMAL

(71) Applicant: SAMSUNG ELECTRONICS CO., LTD., SUWON-SI (KR)

(72) Inventors: Jae-gil Lee, Suwon-si (KR); Susik Yoon, Suwon-si (KR); Byung Suk Lee, Suwon-si (KR); Youngjun Lee, Suwon-si (KR)

(73) Assignee: Korea Advanced Institute Of Science And Technology, Daejeon (KR)

(21) Appl. No.: 18/448,354

(22) Filed: Aug. 11, 2023

(51) Int. Cl. G06N 3/0455

(52) U.S. Cl. CPC G06N 3/0455

(57) ABSTRACT

A method comprises obtaining original data representing one or more characteristics of a target object; selecting an artificial intelligence generation model from among a plurality of artificial intelligence generation models based on the original data; generating reconstructed data based on the original data using the selected artificial intelligence generation model; calculating an anomaly score by comparing the original data and the reconstructed data; and outputting detection result data indicating whether the target object is abnormal based on the anomaly score.

### BACKGROUND

The present disclosure relates to anomaly detection, and more particularly, to a server, method, and system for detecting whether a target object is abnormal using machine learning.

Machine learning can be used to detect outliers within a data set. For example, some machine learning models detect outliers based on distance or density parameters. However, as the dimensionality of the data increases, these distance- or density-based methods may be inadequate for some data analysis tasks. Further, conventional machine learning methods may struggle to adapt robustly to changes in the data distribution. Therefore, there is a need for outlier detection methods that are resilient to distribution changes and are tailored to handle complex data.

### SUMMARY

The present disclosure provides a server, method, and system for detecting whether a target object is abnormal in order to be robust to a change in distribution of high-dimensional data and suitable for the high-dimensional data.

According to embodiments of the present disclosure, a method includes obtaining original data representing one or more characteristics of a target object; selecting an artificial intelligence generation model from among a plurality of artificial intelligence generation models based on the original data; generating reconstructed data based on the original data using the artificial intelligence generation model; calculating an anomaly score by comparing the original data and the reconstructed data; and outputting detection result data indicating whether the target object is abnormal based on the anomaly score.

According to embodiments of the present disclosure, a computing devices includes a memory storing model pool data corresponding to a plurality of artificial intelligence generation models; and a processor configured to obtain original data representing one or more characteristics of a target object; select an artificial intelligence generation model from among the plurality of artificial intelligence generation models based on the original data; generate reconstructed data based on the original data using the selected artificial intelligence generation model; calculate an anomaly score by comparing the original data and the reconstructed data; and output detection result data indicating whether the target object is abnormal based on the anomaly score.

According to embodiments of the present disclosure, a system includes measurement equipment configured to generate original data including multidimensional vectors corresponding to characteristics of a target object; and a server configured to receive the original data, to calculate an anomaly score corresponding to a degree of reconstruction between the original data and reconstructed data of the original data by using an artificial intelligence generation model compatible with the original data among a plurality of artificial intelligence generation models, and to output detection result data indicating whether the target object is abnormal, based on the anomaly score and a reference score.

### BRIEF DESCRIPTION OF THE DRAWINGS

FIG. 1 is a block diagram illustrating a system for detecting whether a target object is abnormal according to embodiments;

FIG. 2 is a diagram illustrating a data stream, a batch, and an anomaly score according to embodiments;

FIG. 3 is a diagram illustrating an artificial intelligence generation model according to embodiments;

FIGS. 4A, 4B, and 4C are diagrams illustrating embodiments of calculating reliability;

FIGS. 5A and 5B are diagrams illustrating an embodiment of updating artificial intelligence generation models;

FIG. 6 is a diagram illustrating an embodiment of merging artificial intelligence generation models;

FIG. 7 is a flowchart illustrating a method of detecting whether a target object is abnormal according to embodiments;

FIG. 8 is a flowchart illustrating an embodiment of calculating a distribution of anomaly scores per batch;

FIG. 9 is a flowchart illustrating an embodiment of calculating an anomaly score by using an artificial intelligence generation model;

FIG. 10 is a flowchart illustrating an embodiment of finding an artificial intelligence generation model compatible with original data;

FIG. 11 is a flowchart illustrating an embodiment of calculating a final anomaly score based on the reliability value of an artificial intelligence generation model;

FIG. 12 is a flowchart illustrating some embodiments of operation S231 of FIG. 11;

FIG. 13 is a flowchart illustrating an embodiment of updating a model pool;

FIG. 14 is a flowchart illustrating some embodiments of operation S261 of FIG. 13;

FIG. 15 is a flowchart illustrating some other embodiments of operation S261 of FIG. 13;

FIG. 16 is a flowchart illustrating an embodiment of merging artificial intelligence generation models;

FIG. 17 is a flowchart illustrating some embodiments of operation S282 of FIG. 16; and

FIG. 18 is a diagram illustrating an embodiment of calculating a final anomaly score.

### DETAILED DESCRIPTION

The present disclosure relates to systems and methods for outlier detection. Machine learning can be used to detect outliers within a data set (e.g., based on distance or density parameters). However, as the dimensionality of the data increases, these distance- or density-based methods may be inadequate for some data analysis tasks. Further, conventional machine learning methods may struggle to adapt robustly to changes in the data distribution.

According to embodiments of the disclosure, a method of detecting whether a target object is abnormal includes receiving original data including a multidimensional vector corresponding to characteristics of the target object, calculating an outlier score corresponding to a degree of restoration between the original data and restored data of the original data by using at least one artificial intelligence generation model compatible with the original data among a plurality of artificial intelligence generation models including an encoder neural network and a decoder neural network, and outputting detection result data indicating whether the target object is abnormal based on the outlier score and a reference score.

Embodiments of the present disclosure will be described in detail with reference to the accompanying drawings.

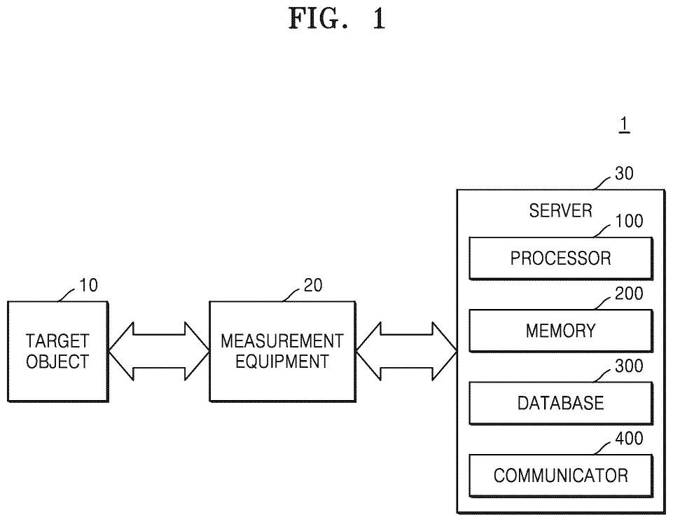

FIG. 1 is a block diagram illustrating the system 1 for detecting whether a target object is abnormal according to embodiments.

Referring to FIG. 1, the system 1 may include a target object 10, measurement equipment 20, and a server 30.

The target object 10 may be an object under examination for anomalous behaviors or characteristics. The target object 10 may include, for example, manufacturing facilities, products before shipment, intermediate products generated in manufacturing processes, and parts used in the manufacturing facilities or the manufacturing processes. The target object 10 may have one or more characteristics. For example, the characteristics of the target object 10 may include temperature, pressure, and/or humidity in a manufacturing facility. For example, the characteristics of the target object 10 may also include the internal temperature, pressure, elasticity, strength, and durability of a product. However, the present disclosure is not limited thereto.

The measurement equipment 20 may measure the characteristics of the target object 10. The measurement equipment 20 may generate original data including multidimensional vectors corresponding to the characteristics of the target object 10 and may transmit the original data to the server 30. For example, each dimension of a multidimensional vector may represent one or more characteristics. A dimension of the vector may correspond to the number of characteristics of the target object 10. For example, as the number of characteristics of the target object 10 increases, the number of dimensions of data or dimensions of vectors may also increase. The challenge associated with analyzing the data due to the increasing dimensionality of the data may be referred to as the complexity of the data. The characteristics of the target object 10 may be changed. For example, process components or manufacturing facilities may be replaced. Accordingly, a distribution of vectors representing the characteristics of the target object 10 may be changed. The fluctuation or change in the distribution of the vectors may be referred to as the variability of data. In some examples, the data may be real-time data or near real-time data such as a data stream.

In some embodiments, the measurement equipment 20 may measure the characteristics of target object 10 in real time and may transmit the original data to the server 30 in real time. The measurement equipment 20 may include an input module, a sensor, a communication module, and a control module in order to measure the characteristics of the target object 10 and to transmit the original data.

The server 30 may detect whether the target object 10 is abnormal from the original data by using an artificial intelligence generation model. The server 30 may refer to various devices for detecting whether the target object 10 is abnormal For example, the server 30 may be a computing device. The server 30 may detect whether the target object 10 is abnormal in real time during the manufacturing processes. The server 30 may include a computer, a server device, and a portable terminal, or may be in any one form. Here, the computer may include, for example, a laptop or a desktop equipped with a web browser. The server device may communicate with an external device to process information, and may include an application server, a computing server, a database server, a file server, and a web server. The portable terminal may be, for example, a wireless communication device that ensures portability and mobility. The portable terminal may include a handheld-based device such as a personal communication system (PCS), a global system for mobile communication (GSM), or a smartphone or a wearable device such as a watch, a ring, a bracelet, an anklet, a necklace, glasses, contact lenses, or a head-mounted-device (HMD).

The server 30 may include a processor 100, a memory 200, a database 300, and a communicator 400.

The processor 100 may receive the original data through the communicator 400. In some examples, processor 100 may use at least one artificial intelligence generation model compatible with the original data among a plurality of artificial intelligence generation models. In some examples, the processor 100 may calculate an anomaly score corresponding to a degree of reconstruction between the original data and reconstructed data of the original data through the artificial intelligence generation model used. In some examples, the processor 100 may output detection result data indicating whether the target object 10 is abnormal based on the anomaly score and a reference score.

A function related to artificial intelligence according to the present disclosure is operated through the processor 100 and the memory 200. At least one processor 100 may include a general-purpose processor such as a central processing unit (CPU), an application processor (AP), or a digital signal processor (DSP), a graphics-only processor such as a graphics processing unit (GPU) or a vision processing unit (VPU), or an artificial intelligence-only processor such as a neural processing unit (NPU).

At least one processor 100 may control input data to be processed according to an operation rule or artificial intelligence model stored in the memory 200. In some examples, the operation rule is predefined. When at least one processor 100 includes the artificial intelligence-only processor, the artificial intelligence-only processor may have a hardware structure specialized for processing a specific artificial intelligence model.

The predefined operation rule or artificial intelligence model may be generated through learning. For example, the artificial intelligence generation model may learn to perform tasks by updating the model's parameters during learning. For example, the learning may be performed by the server 30 in which artificial intelligence according to the present disclosure is performed, or through a separate device, server, and/or system other than the server 30. The learning algorithm may include a supervised learning algorithm, an unsupervised learning algorithm, a semi-supervised learning algorithm, or a reinforcement learning algorithm. However, the present disclosure is not limited thereto.

The artificial intelligence model may include an artificial neural network (ANN) including a plurality of neural network layers. An artificial neural network (ANN) is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

Each of the plurality of neural network layers may have a plurality of weight values. Each of the plurality of neural network layers may perform a neural network operation through an operation between an operation result of a previous layer and a plurality of weights. The plurality of weights may be optimized by a learning result of the artificial intelligence model. For example, the plurality of weights may be updated so that a loss value or a cost value obtained from the artificial intelligence model is reduced or minimized during a learning process. According to some embodiments, during the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

An artificial neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network. However, the present disclosure is not limited thereto.

According to an embodiment, the processor 100 may implement artificial intelligence. Artificial intelligence refers to an artificial neural network-based machine learning method that simulates human biological neurons and allows machines to learn. The methods for machine learning models to learn from data may be divided into supervised learning, unsupervised learning, and reinforcement learning according to a learning method. In some examples, the architectural structure of artificial intelligence may include CNN, RNN, a transformer, and a generative adversarial network (GAN) according to an architecture that is a structure of a learning model.

The processor 100 may implement at least one artificial intelligence model. The artificial intelligence model may include a neural network and may include a learning algorithm that mimics biological neurons in machine learning and cognitive science. A neural network may refer to an overall model in which artificial neurons (nodes) forming a network by synaptic coupling change synaptic coupling strength through learning to have a problem-solving ability. A neuron of the neural network may include a combination of weights or biases. The neural network may include one or more layers consisting of one or more neurons or nodes. For example, the device may include an input layer, a hidden layer, and an output layer. The neural network may infer a result (an output) to be predicted from an arbitrary input by changing the weight of the neuron through learning.

Processor 100 may generate and train the neural network, execute operations based on the received input data, and create an information signal grounded in the operation results. In come examples, the processor 100 may retrain the neural network. The neural network may have models such as CNNs such as GoogleNet, AlexNet, and VGG Network, a region with CNN (R-CNN), a region proposal network (RPN), an RNN, a stacking-based DNN (S-DNN), a state-space dynamic neural network (S-SDNN), a deconvolution network, a DBN, a restricted Boltzman machine (RBM), a fully convolutional network, a long short-term memory (LSTM) network, a classification network, generative modeling, eXplainable AI, continual AI, representation learning, AI for material design, BERT, SP-BERT, MRC/QA, Text Analysis, Dialog System, GPT-3, and GPT-4 for natural language processing, Visual Analytics for vision processing, Visual Understanding, Video Synthesis, Anomaly Detection for ResNet data intelligence, Prediction, Time-Series Forecasting, Optimization, Recommendation, and Data Creation. However, the present disclosure is not limited thereto.

The memory 200 and the processor 100 may be implemented as multiple chips or as a single chip. The memory 200 may include at least one type of storage medium among a flash memory type storage medium, a hard disk type storage medium, a solid state disk (SSD) type storage medium, a silicon disk drive (SDD) type storage medium, a multimedia card micro type storage medium, card type memory (for example, SD or XD memory), random access memory (RAM), static random access memory (SRAM), read-only memory (ROM), electrically erasable programmable read-only memory (EEPROM), programmable read-only memory (PROM), magnetic memory, a magnetic disk, and an optical disk.

The memory 200 may store algorithm data for controlling operations of components in the server 30 or a program reproducing the algorithm. The memory 200 may store data including programs for the functioning of the server 30 and the processor 100, may store input/output data items, and may store a plurality of application programs or applications driven by the server 30 and data items and commands for operation of the server 30. At least some of the application programs may be downloaded from an external server through wireless communication.

The memory 200 may store model pool data. The model pool may include one or more artificial intelligence generation models. The artificial intelligence generation model may include an encoder neural network and a decoder neural network. The artificial intelligence generation model may correspond to the artificial intelligence model and ANN described above.

The database 300 may store the learning data set. In some examples, the database 300 may store the original data provided from the measurement equipment 20 as learning data.

The communicator 400 may communicate with the measurement equipment 20. For example, the communicator 400 may include a wireless communication module supporting wireless communication methods or devices such as a Wi-Fi module, a wireless broadband module, a global system for mobile communication (GSM), long term evolution (LTE), 4G, 5G, and 6G.

As described above, according to the present disclosure, by using an artificial intelligence generation model compatible with high-dimensional data, high-dimensional data may be analyzed despite a change in data distribution. Accordingly, embodiments of the present disclosure may be used to effectively cope with data complexity and data variability.

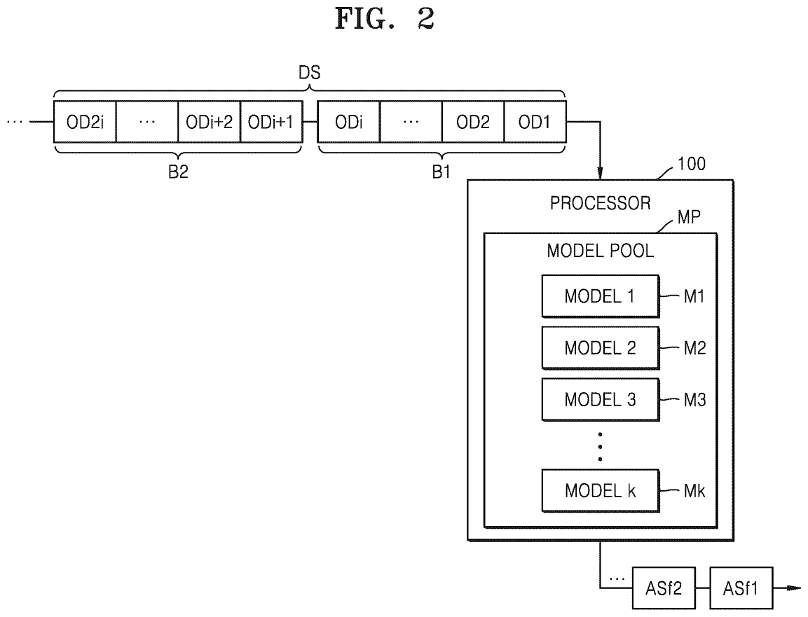

FIG. 2 is a diagram illustrating a data stream DS, a batch, and an anomaly score according to embodiments.

Referring to FIG. 2, the processor 100 may implement a model pool MP. The model pool MP may include the first to the kth artificial intelligence generation models M1, M2, M3, . . . , and Mk. In FIG. 2, the number of artificial intelligence generation models is k. However, the present disclosure is not limited thereto, And k may be a natural number greater than or equal to 2. The plurality of artificial intelligence generation models M1, M2, M3, . . . , and Mk may have different characteristics in order to robustly cope with a change in the distribution of the data stream DS. According to embodiments of the present disclosure, a method or system may adeptly handle the variability of the data stream DS by dynamically employing an artificial intelligence generative model that is suitable for the altered distribution within the data stream DS.

The data stream DS may be provided to the processor 100 in real time. For example, original data items included in the data stream DS may be fed sequentially into the processor 100. The processor 100 may use an artificial intelligence generation model compatible with each of the original data items included in the data stream DS. In some cases, one or more artificial intelligence generation models may be compatible with each of the original data items. The processor 100 may calculate an anomaly score for each of the original data items using an artificial intelligence generation model. For example, the processor 100 may calculate a first anomaly score ASf1 for the first original data OD1 by using an artificial intelligence generation model compatible with the first original data OD1 in the model pool MP. For example, the first original data OD1 may be a multidimensional vector, where each dimension may represent one or more characteristics of the target object. For example, the processor 100 may calculate a second anomaly score ASf2 for the second original data OD2 using an artificial intelligence generation model compatible with the second original data OD2 in the model pool MP. The processor 100 may detect whether the target object 10 is abnormal based on the calculated anomaly score and a reference score. For example, the reference score may be predetermined or be based on a distribution of the anomaly scores.

In some embodiments, the processor 100 may process data in the data stream DS in batches units. Each batch may have a batch size. The batch size may correspond to the number of original data items. For example, when the batch size is i (i is an integer greater than or equal to 2), a first batch B1 may include the first to the i-th original data items OD1, OD2, . . . , and ODi, and a second batch B2 may include the i+1th to the 2ith original data items ODi+1, ODi+2, . . . , and ODi.

However, the present disclosure is not limited thereto. The processor 100 may calculate an anomaly score for each batch by using at least one artificial intelligence generation model compatible with each batch in the model pool MP. For example, the processor 100 may calculate a first anomaly score ASf1 for the first batch B1 by using an artificial intelligence generation model compatible with the first batch B1 in the model pool MP. For another example, the processor 100 may calculate a second anomaly score ASf2 for the second batch B2 by using an artificial intelligence generation model compatible with the second batch B2 in the model pool MP.

According to some embodiments, the obtaining of the original data includes receiving a data stream in real time and dividing the data stream into a plurality of batches, wherein the original data comprises a batch of the plurality of batches. For example, calculating a plurality of anomaly scores corresponding to the plurality of batches and generating distribution data including a distribution of the plurality of anomaly scores.

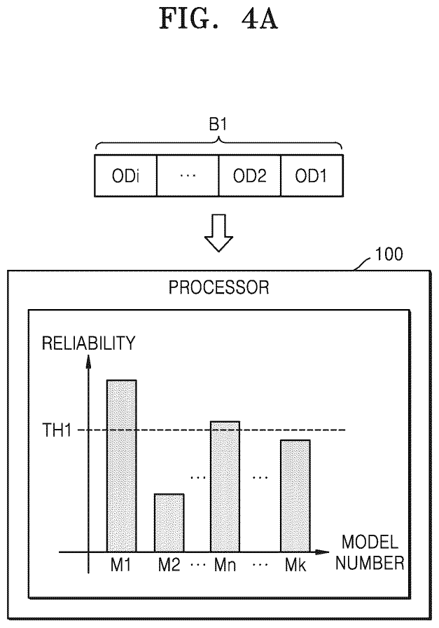

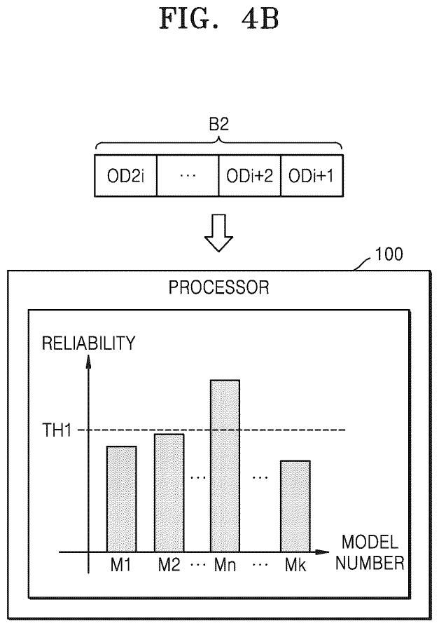

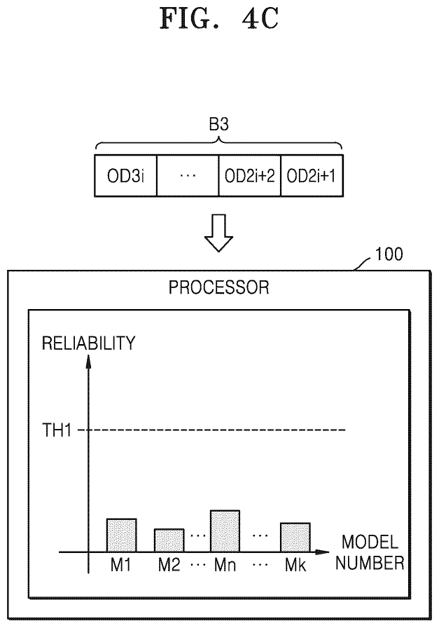

In some embodiments, the processor 100 may calculate anomaly scores of the original data items included in each batch by using at least one artificial intelligence generation model compatible with each batch in the model pool MP, and may detect whether the target object is abnormal based on a comparison between the anomaly scores and the reference score. In some examples, the processor 100 may generate distribution data including a distribution of anomaly scores for each batch. The distribution of the anomaly scores may be used to calculate reliability of each artificial intelligence generation model as described later with reference to FIGS. 4A to 4C.

The artificial intelligence generation model compatible with each batch may refer to an artificial intelligence generation model that best describes the distribution of the original data items (or the distribution of the data stream DS) at a point in time at which the original data items are input to the processor 100.

When the distribution of the data stream DS changes, there is an effect of properly coping with the changed distribution by adaptively using an artificial intelligence generation model suitable for the changed distribution. That is, there is an effect of robustly coping with the variability of the data stream DS.

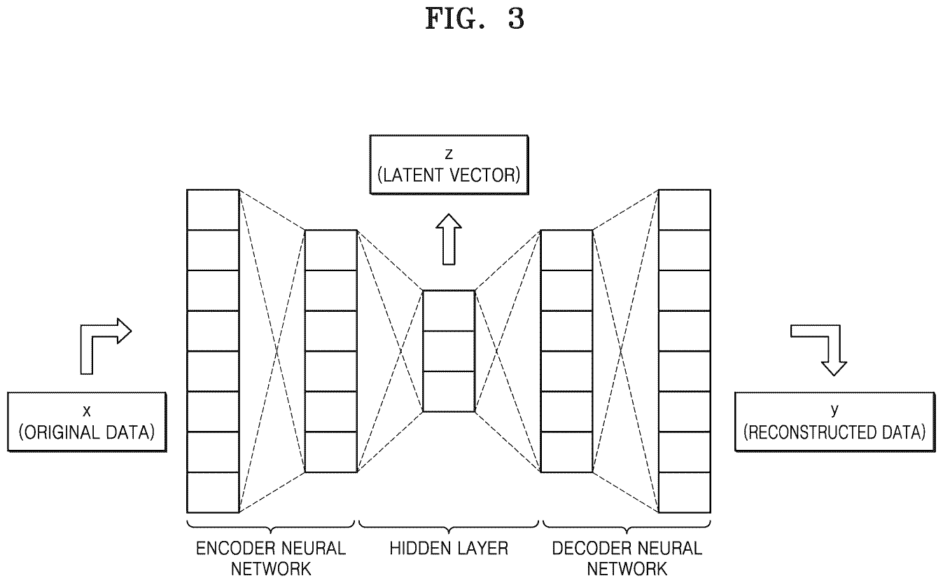

FIG. 3 is a diagram illustrating an artificial intelligence generation model according to embodiments.

Referring to FIG. 3, the artificial intelligence generation model according to embodiments may include any one of the plurality of artificial intelligence generation models M1, M2, M3, . . . , and Mk included in the model pool MP of FIG. 2.

The artificial intelligence generation model according to embodiments may include an encoder neural network ENCODER NEURAL NETWORK, a hidden layer HIDDEN LAYER, and a decoder neural network DECODER NEURAL NETWORK to copy an input to an output. In some embodiments, the artificial intelligence generation model may be implemented as an autoencoder. However, the present disclosure is not limited thereto.

According to some embodiments, the calculating of the anomaly score includes encoding the original data using an encoder neural network of the artificial intelligence generation model to obtain encoded data, decoding the encoded data using a decoder neural network of the at least one artificial intelligence generation model to obtain reconstructed data, and computing a difference between the reconstructed data and the original data. The encoder neural network ENCODER NEURAL NETWORK may include one or more layers. One layer included in the encoder neural network ENCODER NEURAL NETWORK may be implemented as an input layer INPUT. In the artificial intelligence generation model, the number of neurons in the input layer INPUT may be greater than the number of neurons in the hidden layer HIDDEN LAYER. Accordingly, input data x may be compressed. The input data x may be the above-described original data. Compressing the input data x may mean reducing a dimension of the input data x. The encoder neural network ENCODER NEURAL NETWORK may be referred to as an encoder.

The decoder neural network DECODER NEURAL NETWORK may include one or more layers. One layer included in the decoder neural network DECODER NEURAL NETWORK may be implemented as an output layer OUTPUT. In the artificial intelligence generation model, the number of neurons in the output layer OUTPUT may be greater than the number of neurons in the hidden layer HIDDEN LAYER. Accordingly, output data y may be output by reconstructing the input data x after noise is added to the input data x. The output data y may include reconstructed data. The reconstructed data may be obtained by reconstructing the original data input as the input data x. The decoder neural network DECODER NEURAL NETWORK may be referred to as a decoder.

Code data z may be obtained from the hidden layer HIDDEN LAYER. The code data z may include a latent vector. The latent vector may include a vector of a reduced dimension from the dimension of the input data x. The latent vector may be obtained from the original data input to the encoder neural network ENCODER NEURAL NETWORK.

The processor 100 may input the original data to the encoder neural network ENCODER NEURAL NETWORK of the artificial intelligence generation model as the input data x. In some examples, the processor 100 may obtain the reconstructed data output from the decoder neural network DECODER NEURAL NETWORK of the artificial intelligence generation model as the output data y. In some examples, the processor 100 may calculate an anomaly score corresponding to a difference between the reconstructed data and the original data. The difference between the reconstructed data and the original data may be, for example, loss. The processor 100 may store the calculated anomaly score in the memory 200. For example, the processor 100 may store the calculated anomaly score for previously received data (or a previously received data set) in the memory 200. For another example, the processor 100 may store the most recently calculated anomaly score in the memory 200.

In some embodiments, the processor 100 may calculate anomaly scores for each batch by using the artificial intelligence generation model and may store distribution data including a distribution of the anomaly scores in the memory 200. For example, the processor 100 may store the distribution of the anomaly scores calculated for the previously received data set and/or the distribution of the anomaly scores of the most recently calculated batch in memory 200. For another example, the processor 100 may store the most recently calculated anomaly score in the memory 200.

According to the present disclosure, an anomaly score may correspond to a reconstruction ability from a low-dimensional base space to an original space. There is a property that the reconstruction ability of abnormal data is lower than that of normal data. According to these properties, data with a relatively low reconstruction ability may be regarded as data measured from the abnormal target object 10. A method of detecting whether the target object 10 is abnormal by using a reconstruction ability-based anomaly score according to an embodiment may be more effective for high-dimensional data than distance/density-based outlier detection. Accordingly, the present disclosure may effectively cope with the difficulty of data analysis (that is, the complexity of the data stream DS) due to an increase in data dimension.

The processor 100 may determine compatibility between the original data and an artificial intelligence generation model based at least in part on a reliability value of each artificial intelligence generation model for currently input original data (or a currently input batch). Hereinafter, embodiments of calculating the reliability value of the artificial intelligence generation model for determining compatibility between the original data and the artificial intelligence generation model will be described.

FIGS. 4A, 4B, and 4C are diagrams illustrating embodiments of calculating reliability value of the present disclosure. FIG. 4A illustrates reliability value of each artificial intelligence generation model for a first batch B1, FIG. 4B illustrates reliability value of each artificial intelligence generation model for a second batch B2 after the first batch B1, and FIG. 4C illustrates reliability value of each artificial intelligence generation model for a third batch B3 after the second batch B2.

In some embodiments, the processor 100 may calculate first reliability value based on a first anomaly score and a second anomaly score. The first anomaly score may include an anomaly score of data (or a data set) previously received in one artificial intelligence generation model. The number of first anomaly scores may depend on the number of artificial intelligence generation models included in a model pool MP. The second anomaly score may include an anomaly score for currently input original data. The first reliability value may include a value corresponding to compatibility between the currently input original data and a specific artificial intelligence generation model. The processor 100 may select an artificial intelligence generation model compatible with the original data from the first to the k-th artificial intelligence generation models M1, M2, . . . , and Mk based on the first reliability value and a first reference value TH1.

Referring to FIG. 4A, for example, the first original data OD1 is input to the processor 100. The processor 100 may calculate the second anomaly score for the first original data OD1 by using the first artificial intelligence generation model M1. The processor 100 may load the first anomaly score for data previously received in the first artificial intelligence generation model M1 from the memory 200. The processor 100 may calculate a difference between the first anomaly score and the second anomaly score. The processor 100 may obtain the calculated difference as the first reliability value of the first artificial intelligence generation model M1 for the first original data OD1. Similarly, the processor 100 may calculate the second anomaly score for the first original data OD1 by using the second artificial intelligence generation model M2. The processor 100 may obtain the first reliability of the second artificial intelligence generation model M2 for the first original data OD1 by comparing the first anomaly score of the second artificial intelligence generation model M2 and the second anomaly score of the first original data OD1. Similarly, the first reliability for each of the other artificial intelligence generation models included in the model pool MP may be calculated as illustrated in FIG. 4A. Assuming that the first artificial intelligence generation model M1 and the nth artificial intelligence generation model Mn have first reliability value greater than the first reference value TH1, the first artificial intelligence generation model M1 and the nth artificial intelligence generation model Mn are compatible with the first original data OD1, and may be selected by the processor 100. In some examples, when the first original data OD1 is input, the processor 100 may calculate a final anomaly score for the first original data OD1 by using the first artificial intelligence generation model M1 and the nth artificial intelligence generation model Mn. Similar to an embodiment in which an artificial intelligence generation model compatible with the first original data OD1 is searched, at least one artificial intelligence generation model compatible with each of second to i-th original data items OD2 to ODi may be searched.

According to some embodiments, the selecting of the artificial intelligence generation model includes calculating a first anomaly score based on previously received data, calculating a second anomaly score based on the original data using the artificial intelligence generation model, and calculating a first reliability value representing a compatibility between the original data and the artificial intelligence generation model based on the first anomaly score and the second anomaly score, wherein the artificial intelligence generation model is selected based at least in part on the first reliability value.

In some other embodiments, the processor 100 may calculate the first reliability value based on a distribution of the first anomaly scores of the previously received data and a distribution of the second anomaly scores of each batch. The distribution of the first anomaly scores may include anomaly scores of a data set previously received in one artificial intelligence generation model. The distribution of the second anomaly scores may include anomaly scores of original data items of a currently input batch. The processor 100 may select the artificial intelligence generation model compatible with the original data from the the first to the k-th artificial intelligence generation models M1, M2, . . . , and Mk based at least in part on the first reliability value and the first reference value TH1.

Referring to FIG. 4A, for example, when the first batch B1 is currently input to the processor 100, the processor 100 may calculate second outliers scores for the first to the i-th original data items OD1, OD2, . . . , and ODi by using the first artificial intelligence generation model M1. The processor 100 may load the first anomaly scores of the data set previously received in the first artificial intelligence generation model M1 from the memory 200. The processor 100 may calculate a difference between the distribution of the first anomaly scores and the distribution of the second anomaly scores. The processor 100 may obtain the calculated difference as the first reliability value of the first artificial intelligence generation model M1 for the first batch B1. Similarly, as illustrated in FIG. 4A, the processor 100 may calculate the first reliability value of each of the second to k-th artificial intelligence generation models M2 to Mk for the first batch B1.

Referring to FIG. 4B, the processor 100 may calculate the first reliability value based on the first anomaly score of each artificial intelligence generation model and the second anomaly score of each original data item included in the second batch B2. Alternatively, the processor 100 may calculate the first reliability value based on the distribution of the first anomaly scores of each artificial intelligence generation model and the distribution of the second anomaly scores of the second batch B2. The first reliability value of the first to the k-th artificial intelligence generation models M1, M2, . . . , Mn, . . . , and Mk for the second batch B2 (or each original data item included in the second batch B2) may be calculated as illustrated in FIG. 4B. In FIG. 4B, because the first reliability value of the nth artificial intelligence generation model Mn is greater than the first reference value TH1, the nth artificial intelligence generation model Mn may be compatible with the second batch B2 (or a specific original data item included in the second batch B2).

In FIG. 4C, the processor 100 may calculate the first reliability value based on the distribution of the first anomaly scores of each artificial intelligence generation model and the distribution of the second anomaly scores of the third batch B3. The first reliability value of the first to the k-th artificial intelligence generation models M1, M2, . . . , Mn, . . . , and Mk for the third batch B3 may be calculated as illustrated in FIG. 4C. In FIG. 4C, when the first reliability value of the first to the k-th artificial intelligence generation models M1, M2, . . . , Mn, . . . , and Mk is less than the first reference value TH1, an artificial intelligence generation model compatible with the third batch B3 may not exist in the model pool MP. In this case, a new artificial intelligence generation model needs to be added to the model pool MP.

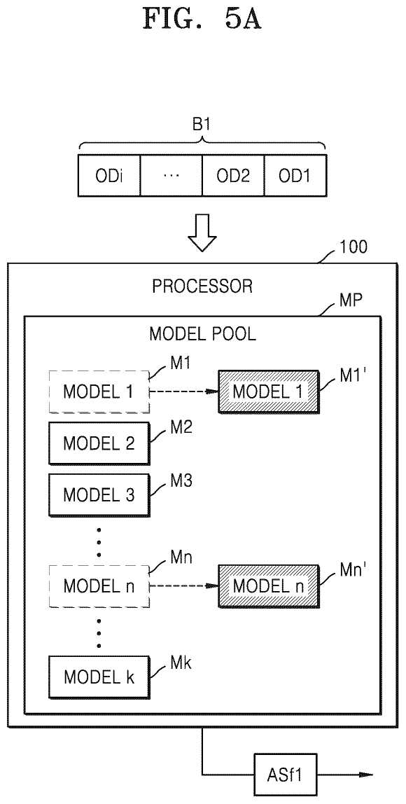

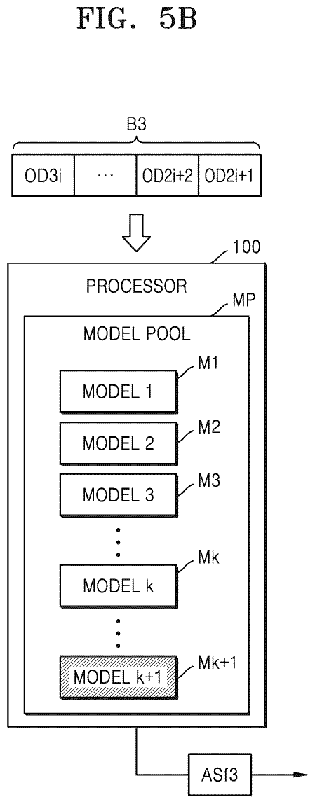

FIGS. 5A and 5B are diagrams illustrating an embodiment of updating artificial intelligence generation models.

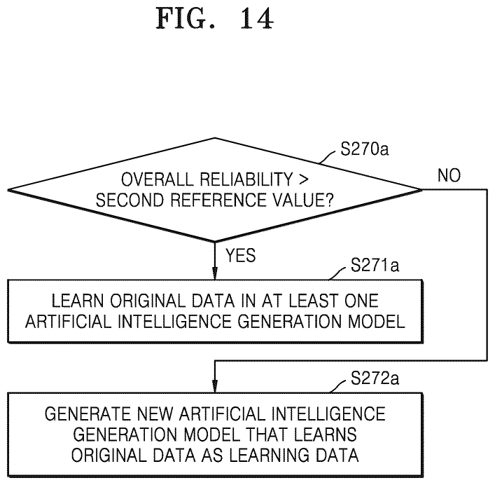

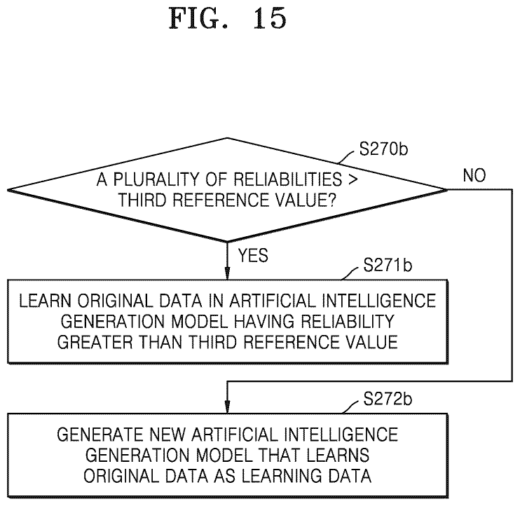

Referring to FIGS. 5A and 5B, the processor 100 may update the model pool MP based on first to the k-th reliabilities of the first to the k-th artificial intelligence generation models M1, M2, M3, . . . , Mn, . . . , and Mk. Embodiments of using the first to the k-th reliabilities when updating the model pool MP are described below with reference to FIGS. 14 and 15.

In some embodiments, updating the model pool MP may be learning the currently input batch to an existing artificial intelligence generation model included in the model pool MP as learning data. Referring to FIGS. 4A and 5A, for example, the first artificial intelligence generation model M1 and the nth artificial intelligence generation model Mn may be compatible with the first batch B1 in the model pool MP. Accordingly, the first anomaly score ASf1 for the first batch B1 is calculated, and the first artificial intelligence generation model M1 and the nth artificial intelligence generation model Mn may be updated by learning the first batch B1. A first artificial intelligence generation model M1′ may correspond to the updated first artificial intelligence generation model M1. An nth artificial intelligence generation model Mn′ may correspond to the updated nth artificial intelligence generation model Mn.

According to some embodiments, a method includes training a new artificial intelligence generation model using the original data, generating a first latent vector using the new artificial intelligence generation model, generating a second latent vector using each of the plurality of the artificial intelligence generation models, comparing the first latent vector to the second latent vector for each of the plurality of artificial intelligence generation models, respectively, selecting a similar artificial intelligence generation model from the plurality of artificial intelligence generation models based on the comparison, and merging the new artificial intelligence generation model with the similar artificial intelligence generation model.

In some embodiments, updating the model pool MP may be adding a new artificial intelligence generation model that learns the currently input batch to the model pool MP. Referring to FIGS. 4C and 5B, for example, an artificial intelligence generation model compatible with the third batch B3 may not exist in the current model pool MP. Accordingly, the (k+1)th artificial intelligence generation model Mk+1 may be generated and added to the model pool MP. The (k+1)th artificial intelligence generation model Mk+1 may be a new artificial intelligence generation model that learns the third batch B3. Meanwhile, the processor 100 may calculate a third anomaly score ASf3 of the third batch B3 by using the (k+1)th artificial intelligence generation model Mk+1.

In some other embodiments, when a new artificial intelligence generation model is added to the model pool MP, storage capacity of the processor 100 and/or storage capacity of the memory 200 may be insufficient. Therefore, similar artificial intelligence generation models may be merged to solve the insufficiency.

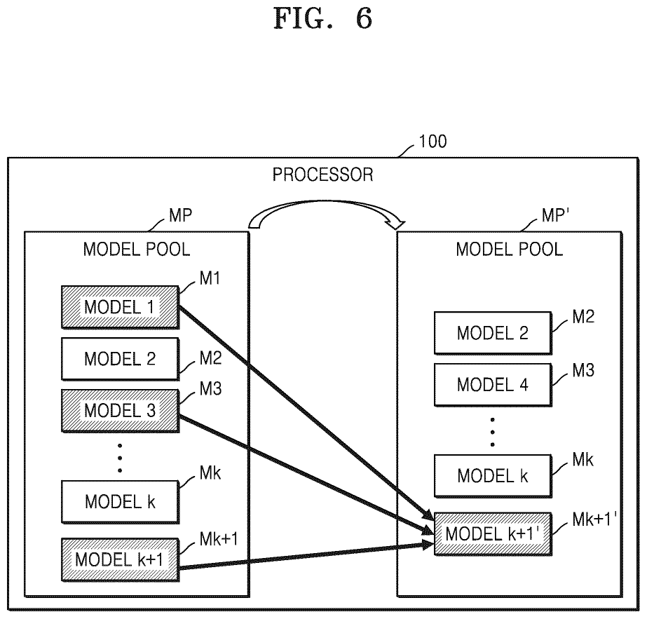

FIG. 6 is a diagram illustrating an embodiment of merging artificial intelligence generation models.

Referring to FIG. 6, the processor 100 may update the model pool MP by generating a new artificial intelligence generation model (for example, the (k+1)th artificial intelligence generation model Mk+1) that learns the original data as learning data. In this case, the processor 100 may search for artificial intelligence generation models similar to the (k+1)th artificial intelligence generation model Mk+1 from the model pool MP. The first artificial intelligence generation model M1 and the third artificial intelligence generation model M3 are similar to the (k+1)th artificial intelligence generation model Mk+1. The processor 100 may generate a (k+1)th artificial intelligence generation model Mk+1′ by integrating the first artificial intelligence generation model M1, the third artificial intelligence generation model M3, and the (k+1)th artificial intelligence generation model Mk+1. The integration of these AI generative models may involve preserving one of the models intended for integration and removing the rest. Alternatively, the integration process could entail creating a new artificial intelligence generation model encompassing characteristics of the artificial intelligence generation models for merging, followed by the removal of the original models slated for integration. As described above, there is an effect of efficiently managing a storage space of the processor 100 and/or a storage space of the memory 200.

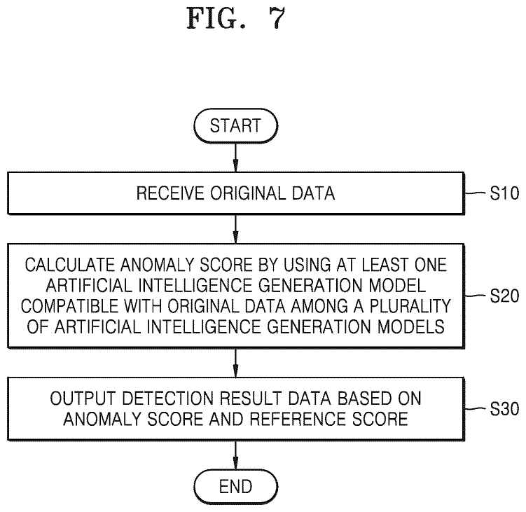

FIG. 7 is a flowchart illustrating a method of detecting whether a target object is abnormal according to embodiments.

Referring to FIG. 7, the method according to the present disclosure may be performed by the server 30 of FIG. 1.

The original data is received in operation S10. The original data may include multidimensional vectors corresponding to the characteristics of the target object 10. For example, each dimension of a multidimensional vector may correspond to one or more characteristics of the target object 10.

An anomaly score is calculated by using at least one artificial intelligence generation model compatible with the original data among the first to the k-th artificial intelligence generation models M1, M2, . . . , and Mk in operation S20. One artificial intelligence generation model may include an encoder neural network ENCODER NEURAL NETWORK and a decoder neural network DECODER NEURAL NETWORK. The anomaly score may correspond to a degree of reconstruction (or a reconstruction ability) between the original data and reconstructed data of the original data.

Detection result data is output based on the anomaly score and the reference score in operation S30. The detection result data may include a result indicating whether the target object 10 is abnormal.

As described above, there is an effect of efficiently detecting whether the target object 10 is abnormal for a high-dimensional data stream DSO.

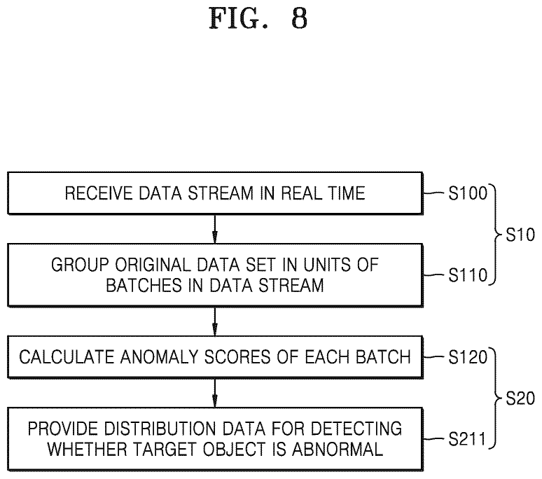

FIG. 8 is a flowchart illustrating an embodiment of calculating a distribution of anomaly scores per batch.

Referring to FIG. 8, operation S10 may include operation S100 and operation S110. The data stream DS is received in real time in operation S100. In the data stream DS, original data sets are grouped in units of batches in operation S110. Referring to FIG. 2, for example, when the batch size is i, an original data set including the first to the i-th original data items OD1 to ODi may be grouped into the first batch B1, and an original data set including the i+1th to 2ith original data items ODi+1 to OD2i may be grouped into the second batch B2.

Operation S20 may include operation S210 and operation S211. Anomaly scores of each batch are calculated in operation S210. Distribution data including a distribution of anomaly scores for detecting whether a target object is abnormal is provided in operation S211. Referring to FIG. 2, for example, anomaly scores of the first batch B1 may be calculated, and anomaly scores of the second batch B2 may be calculated. In some examples, distribution data including a distribution of the anomaly scores of the first batch B1 may be generated, and distribution data including a distribution of the anomaly scores of the second batch B2 may be generated.

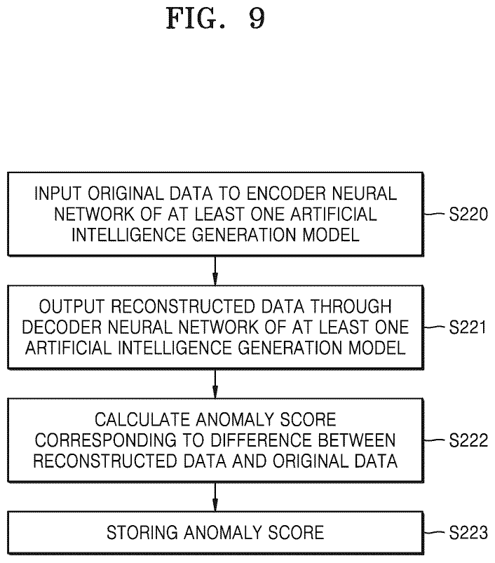

FIG. 9 is a flowchart illustrating an embodiment of calculating an anomaly score by using an artificial intelligence generation model.

Referring to FIG. 9, operations S220, S221, S222, and S223 of FIG. 9 may be included in the operation S20 of FIG. 7. The operations S220, S221, S222, and S223 of FIG. 9 may be the same as those of the embodiment described above with reference to FIG. 3.

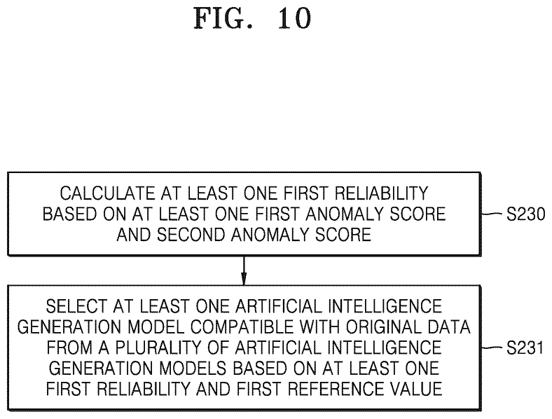

Original data is input to an encoder neural network ENCODER NEURAL NETWORK of at least one artificial intelligence generation model in operation S220. In operation S221, the reconstructed data is produced via a decoder neural network, DECODER NEURAL NETWORK, within at least one operational artificial intelligence generative model. Operation S222 involves calculating an anomaly score that corresponds to the discrepancy between the reconstructed data and the original data. This anomaly score is then stored in operation S223. FIG. 10 is a flowchart illustrating an embodiment of finding an artificial intelligence generation model compatible with original data.

Referring to FIG. 10, operations S230 and S231 of FIG. 10 may be included in the operation S20 of FIG. 7. The operations S230 and S231 of FIG. 10 may be the same as those of the embodiment described above with reference to FIGS. 4A, 4B, and 4C.

At least one first reliability value is calculated based on at least one first anomaly score and a second anomaly score in operation S230. The first anomaly score may include an anomaly score of a data set previously received in one artificial intelligence generation model. When the number of artificial intelligence generation models is 2 or more, the number of first anomaly scores and the number of first reliabilities may also be 2 or more. The first reliability value may correspond to compatibility between the original data and one artificial intelligence generation model.

Based on at least one first reliability value and a first reference value, at least one artificial intelligence generation model compatible with the original data is selected from a plurality of artificial intelligence generation models in operation S231.

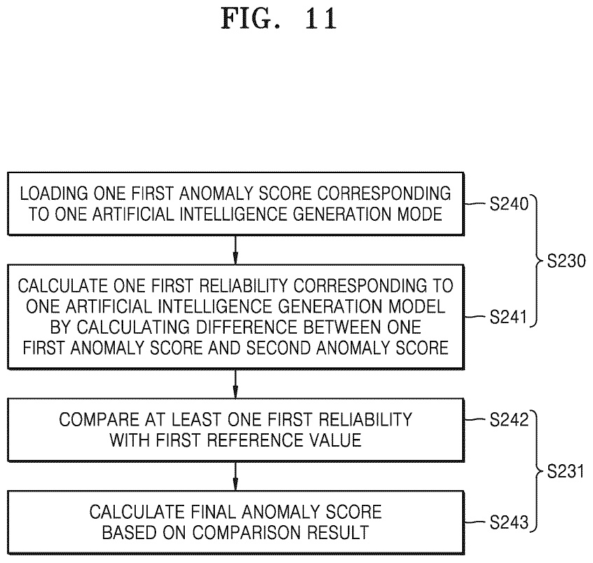

FIG. 11 is a flowchart illustrating an embodiment of calculating a final anomaly score based at least in part on reliability value of an artificial intelligence generation model.

Referring to FIG. 11, the operation S230 of FIG. 11 may include operations S240 and S241. One first anomaly score corresponding to one artificial intelligence generation model is loaded in operation S240. By comparing the first anomaly score and a second anomaly score, one first reliability value corresponding to one artificial intelligence generation model is calculated in operation S241. For example, the processor 100 may calculate the second anomaly score by using the first artificial intelligence generation model M1. The processor 100 may load the first anomaly score of the first artificial intelligence generation model M1 from the memory 200. The processor 100 may obtain the first reliability value of the first artificial intelligence generation model M1 by calculating the difference between the first anomaly score and the second anomaly score. The operations S240 and S241 described above are also performed on the second to k-th artificial intelligence generation models M2 to Mk.

The operation S231 of FIG. 11 may include operations S242 and S243. The at least one first reliability value is compared with the first reference value TH1 in operation S242. The final anomaly score is calculated in response to the comparison result in operation S243.

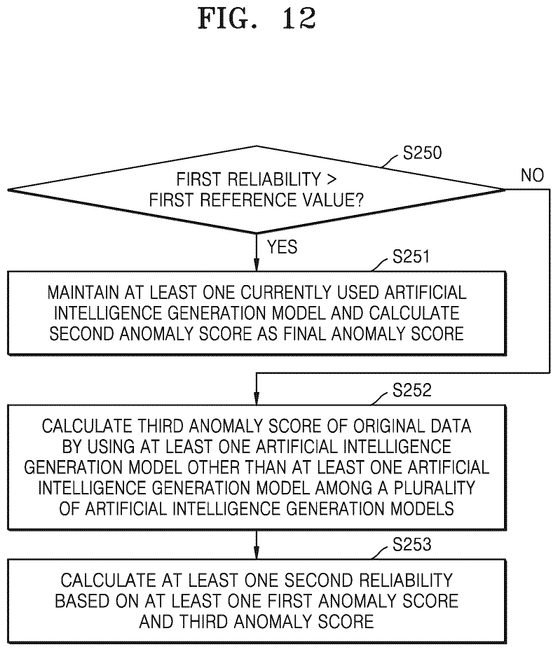

FIG. 12 is a flowchart illustrating some embodiments of the operation S231 of FIG. 11.

Referring to FIG. 12, it is determined whether the first reliability value is greater than the first reference value TH1 in operation S250.

When it is determined that the first reliability value is greater than the first reference value TH1 in operation S250, at least one currently used artificial intelligence generation model is maintained and the second anomaly score is calculated as the final anomaly score in operation S251. For example, The currently used artificial intelligence generation model is the first artificial intelligence generation model M1 and the first batch B1 is currently input to the processor 100. The processor 100 calculates a second anomaly score of the first batch B1 by using the first artificial intelligence generation model M1. In some examples, when the first reliability value of the first artificial intelligence generation model M1 is greater than the first reference value TH1, the processor 100 calculates the second anomaly score of the first batch B1 as the final anomaly score. In some examples, the processor 100 may calculate a second anomaly score of a subsequent batch (for example, the second batch B2) by using the first artificial intelligence generation model M1. For another example, the first artificial intelligence generation model M1, the second artificial intelligence generation model M2, and the third artificial intelligence generation model M3 are currently used. The second anomaly score of the first batch B1 may be calculated by a combination of anomaly scores output by the first artificial intelligence generation model M1, the second artificial intelligence generation model M2, and the third artificial intelligence generation model M3. When the first reliability value of each of the first artificial intelligence generation model M1, the second artificial intelligence generation model M2, and the third artificial intelligence generation model M3 is greater than the first reference value TH1, the second anomaly score of the first batch B1 may be calculated as the final anomaly score.

When it is determined that the first reliability value is less than or equal to the first reference value TH1 in operation S250, a more accurate anomaly score than the second anomaly score is required. Therefore, a third anomaly score of the original data is calculated by using another artificial intelligence generation model, among the first to the k-th artificial intelligence generation models M1, M2, . . . , and Mk in operation S252. For example, the currently used artificial intelligence generation model may be the first artificial intelligence generation model M1, and the first reliability value of the first artificial intelligence generation model M1 may be less than the first reference value TH1. In this case, the processor 100 may calculate a third anomaly score of the currently input original data (or the currently input batch) by using at least one artificial intelligence generation model among the second to k-th artificial intelligence generation models M2 to Mk. Meanwhile, at least one second reliability value is calculated based on the at least one first anomaly score and the third anomaly score in operation S252. The second reliability value may include a value corresponding to compatibility between the original data and the at least one other artificial intelligence generation model described above.

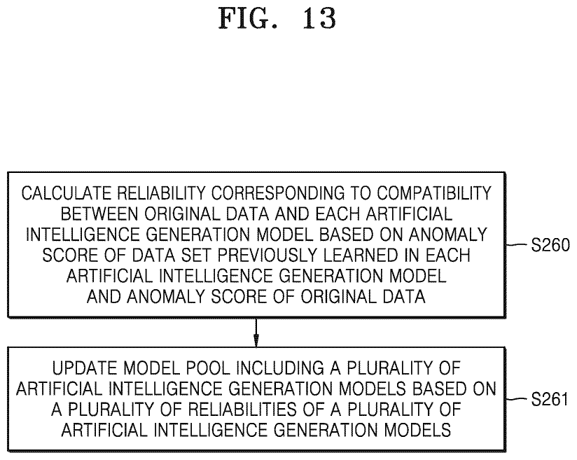

FIG. 13 is a flowchart illustrating an embodiment of updating a model pool.

Referring to FIG. 13, operations S260 and S261 of FIG. 13 may be included in the operation S20 of FIG. 7. The operations S260 and S261 of FIG. 13 may be the same as those of the embodiment described above with reference to FIGS. 4A, 4B, 4C, 5A, and 5B.

A reliability value corresponding to compatibility between the original data and each artificial intelligence generation model is calculated based on an anomaly score of a data set previously received in each artificial intelligence generation model and an anomaly score of the original data in operation S260.

A model pool including a plurality of artificial intelligence generation models is updated based on a plurality of reliabilities of a plurality of artificial intelligence generation models in operation S261.

FIG. 14 is a flowchart illustrating some embodiments of the operation S261 of FIG. 13.

Referring to FIG. 14, it is determined whether an overall reliability value is greater than a second reference value in operation S270a. The overall reliability value may include a reliability value of the model pool MP. For example, the processor 100 may calculate the overall reliability value of the model pool MP based on the plurality of reliabilities. For example, the overall reliability value (Rₚ) of the model pool MP may be calculated according to Equation 1 below.

$${R}_{p} = 1 - {\prod }_{x = 1}^{k} ( 1 - {Reliability}_{x} )$$

wherein, Reliabilityₓ may include a reliability value of an arbitrary artificial intelligence generation model of the model pool MP.

When it is determined that the overall reliability value is greater than the second reference value in S270a, the currently input original data (or the currently input batch) is learned to at least one currently used artificial intelligence generation model in operation S271a. As the currently used artificial intelligence generation model is learned, the model pool MP may be updated. That is, when an artificial intelligence generation model compatible with currently input data exists in the model pool MP, only the corresponding artificial intelligence generation model may be updated.

When it is determined that the overall reliability value is less than or equal to the second reference value in operation S270a, a new artificial intelligence generation model that learns the currently input original data (or the currently input batch) as learning data is generated in operation S272a. The model pool MP may be updated by having the new artificial intelligence generation model added to the model pool MP. That is, when any artificial intelligence generation model existing in the model pool MP is not compatible with the currently input data, a new artificial intelligence generation model learning the currently input data may be generated.

FIG. 15 is a flowchart illustrating some other embodiments of the operation S261 of FIG. 13.

Referring to FIG. 15, it is determined whether a plurality of reliabilities are all greater than a third reference value in operation S270b. The plurality of reliabilities may include reliabilities of the first to the k-th artificial intelligence generation models M1, M2, . . . , and Mk included in the model pool MP. For example, the processor 100 may determine whether each of the plurality of reliabilities is greater than the third reference value.

When it is determined that at least one of the plurality of reliabilities is greater than the third reference value in operation S270b, original data is learned in an artificial intelligence generation model having a reliability value greater than the third reference value among the plurality of reliabilities in operation S271b.

When it is determined that the plurality of reliability value are less than or equal to the third reference value in operation S270b, a new artificial intelligence generation model that learns the original data as learning data is generated in operation S272b.

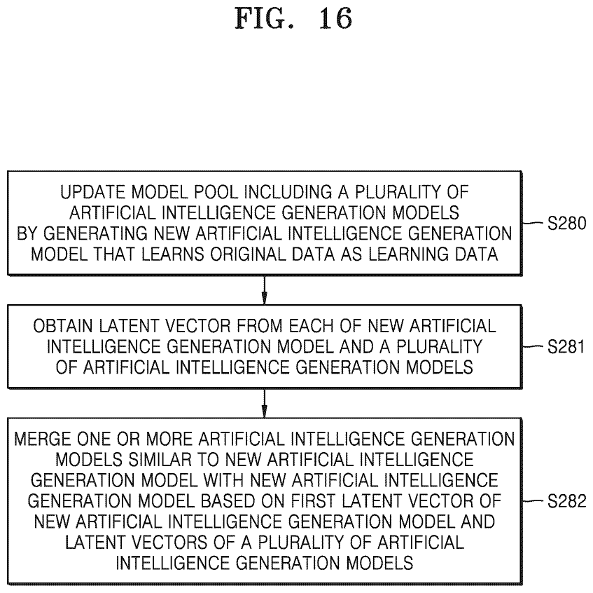

FIG. 16 is a flowchart illustrating an embodiment of merging artificial intelligence generation models.

Referring to FIG. 16, operations S280, S281, and S282 of FIG. 16 may be included in the operation S20 of FIG. 7. The operations S280, S281, and S282 of FIG. 16 may be the same as those of the embodiment described above with reference to FIGS. 3 and 6.

By generating a new artificial intelligence generation model (for example, the (k+1)th artificial intelligence generation model Mk+1) that learns the original data as learning data, the model pool MP including the first to the k-th artificial intelligence generation models M1, M2, . . . , and Mk is updated in operation S280.

A latent vector is obtained from each of the new artificial intelligence generation model and the first to the k-th artificial intelligence generation models M1, M2, . . . , and Mk in operation S281. The latent vector may include a code (for example, code data z) output from an encoder neural network ENCODER NEURAL NETWORK. For example, a first latent vector of the new artificial intelligence generation model may be obtained, and a latent vector of each artificial intelligence generation model included in the model pool MP may be obtained.

Based on the first latent vector of the new artificial intelligence generation model and the latent vectors of the plurality of artificial intelligence generation models, one or more artificial intelligence generation models similar to the new artificial intelligence generation model are merged with the new artificial intelligence generation model in operation S282.

According to some embodiment, the model pool may be operated by controlling the number of artificial intelligence generation models included in the model pool MP.

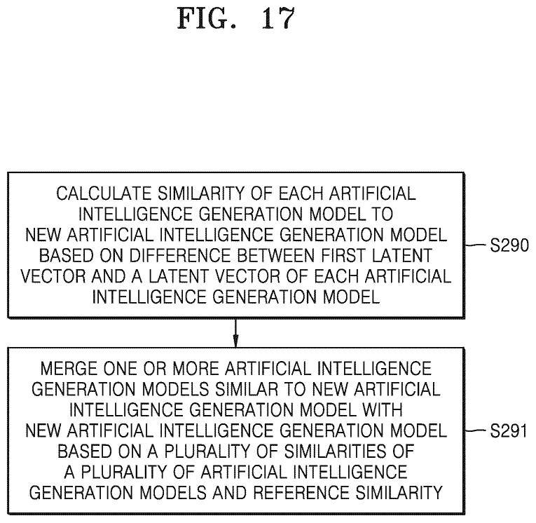

FIG. 17 is a flowchart illustrating some embodiments of the operation S282 of FIG. 16.

Referring to FIG. 17, similarity of each artificial intelligence generation model to a new artificial intelligence generation model. For example, the (k+1)th artificial intelligence generation model Mk+1 is calculated based on a difference between the first latent vector and a latent vector of each artificial intelligence generation model in operation S290. For example, the processor 100 may calculate a difference between a first latent vector of the (k+1)th artificial intelligence generation model Mk+1 and a latent vector of the first artificial intelligence generation model M1, and may calculate a similarity between the first artificial intelligence generation model M1 and the (k+1)th artificial intelligence generation model Mk+1 based on the difference. In some cases, a similarity between the second artificial intelligence generation model M2 and the (k+1)th artificial intelligence generation model Mk+1 may be calculated, and a similarity of each of the remaining artificial intelligence generation models M3, . . . Mn, . . . and Mk in the model pool MP may be calculated.

Based on a plurality of similarities of a plurality of artificial intelligence generation models and a reference similarity, one or more artificial intelligence generation models similar to the new artificial intelligence generation model are merged with the new artificial intelligence generation model in operation S291.

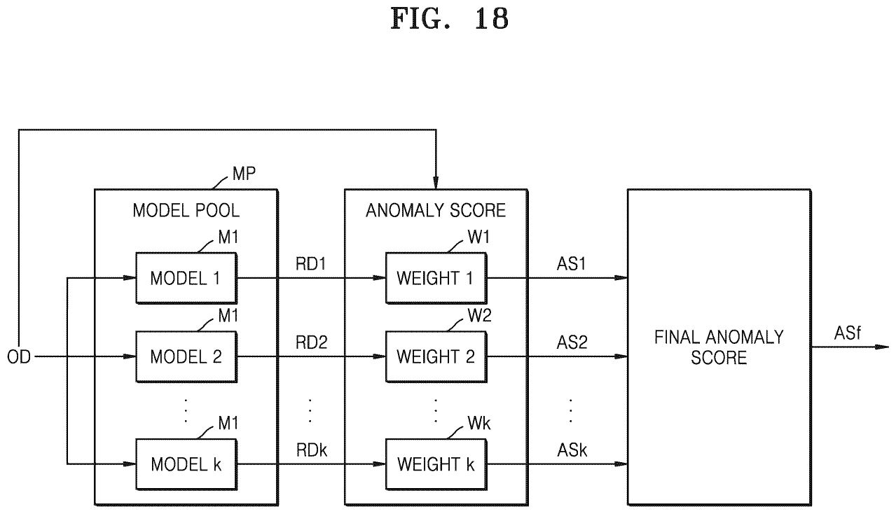

FIG. 18 is a diagram illustrating an embodiment of calculating a final anomaly score.

Referring to FIG. 18, in some embodiments using at least one artificial intelligence generation model, the processor 100 may assign a weight to an anomaly score calculated by using each artificial intelligence generation model according to reliability value. Accordingly, an artificial intelligence generation model with a relatively high reliability value may contribute more to calculating the anomaly score.

The original data OD may be input to the first to the k-th artificial intelligence generation models M1, M2, . . . , and Mk of the model pool MP, and the first to the k-th reconstructed data items RD1, RD2, . . . , and RDk may be respectively output from the first to the k-th artificial intelligence generation models M1, M2, . . . and Mk.

A weight may be reflected to an anomaly score corresponding to a difference between each of the the first to the k-th reconstructed data items RD1, RD2, . . . , and RDk and the original data OD. For example, the anomaly score corresponding to the difference between the original data OD and the first reconstructed data RD1 is calculated, and a first weight W1 according to a reliability value of the first artificial intelligence generation model M1 is reflected to the anomaly score so that a first anomaly score AS1 may be calculated. Similarly, a second anomaly score AS2, to which a second weight W2 according to a reliability value of the second artificial intelligence generation model M2 is reflected, may be calculated, and a k-th anomaly score ASk, to which a k-th weight Wk according to a reliability value of the k-th artificial intelligence generation model Mk is reflected, may be calculated. A final anomaly score ASf corresponding to a combination of the first to the k-th anomaly scores AS1, AS2, . . . , and ASk may be calculated.

The first to the k-th weights W1, W2, . . . , and Wk used to calculate the above-described anomaly score may be changed according to a reliability value of a corresponding artificial intelligence generation model.

The singular expression of the present disclosure may include a plurality of expressions, unless otherwise specified. For example, the indefinite article “a/an” in the present disclosure may be interpreted as at least one. For example, an artificial intelligence generation model may be interpreted as at least one artificial intelligence generation model. For example, a memory may be interpreted as at least one memory. For example, a processor may be interpreted as as at least one processor.

While the present disclosure has been particularly shown and described with reference to embodiments thereof, it will be understood that various changes in form and details may be made therein without departing from the spirit and scope of the following claims.

Please enter the following amendments to the claims:

1. A method comprising:
obtaining original data representing one or more characteristics of a target object;
selecting an artificial intelligence generation model from among a plurality of artificial intelligence generation models based on the original data;
generating reconstructed data based on the original data using the artificial intelligence generation model;
calculating an anomaly score by comparing the original data and the reconstructed data; and
outputting detection result data indicating whether the target object is abnormal based on the anomaly score.

2. The method of claim 1, wherein the obtaining of the original data comprises:
receiving a data stream in real time and dividing the data stream into a plurality of batches, wherein the original data comprises a batch of the plurality of batches; and
wherein the method further comprises:
calculating a plurality of anomaly scores corresponding to the plurality of batches and generating distribution data including a distribution of the plurality of anomaly scores.

3. The method of claim 1, wherein the calculating of the anomaly score comprises:
encoding the original data using an encoder neural network of the artificial intelligence generation model to obtain encoded data;
decoding the encoded data using a decoder neural network of the artificial intelligence generation model to obtain reconstructed data; and
computing a difference between the reconstructed data and the original data.

4. The method of claim 1, wherein the selecting of the artificial intelligence generation model comprises:
calculating a first anomaly score based on previously received data;
calculating a second anomaly score based on the original data using the artificial intelligence generation model; and
calculating a first reliability value representing a compatibility between the original data and the artificial intelligence generation model based on the first anomaly score and the second anomaly score, wherein the artificial intelligence generation model is selected based at least in part on the first reliability value.

5. The method of claim 4, wherein the calculating of the first reliability value comprises:
comparing the first anomaly score and the second anomaly score.

6. The method of claim 4, wherein the selecting of the artificial intelligence generation model further comprises:
determining that the first reliability value is greater than a first reference value.

7. The method of claim 4, wherein the selecting of the artificial intelligence generation model further comprises:
calculating a third anomaly score based on the original data using another artificial intelligence generation model; and
calculating a second reliability value representing a compatibility between the original data and the another artificial intelligence generation model based on the first anomaly score and the third anomaly score, wherein the artificial intelligence generation model is selected based at least in part on the second reliability value.

8. The method of claim 1, wherein the selecting of the artificial intelligence generation model comprises:
calculating a first anomaly score based on previously received data using each of the plurality of artificial intelligence generation models;
calculating a second anomaly score based on the original data using each of the plurality of artificial intelligence generation models;
calculating a reliability value corresponding to a compatibility between the original data and each of the plurality of artificial intelligence generation models, respectively, based on the first anomaly score and the second anomaly score; and
updating a model pool including the plurality of artificial intelligence generation models based on the reliability value.

9. The method of claim 1, further comprising:
training a new artificial intelligence generation model using the original data;
generating a first latent vector using the new artificial intelligence generation model;
generating a second latent vector using each of the plurality of the artificial intelligence generation models;
comparing the first latent vector to the second latent vector for each of the plurality of artificial intelligence generation models, respectively;
selecting a similar artificial intelligence generation model from the plurality of artificial intelligence generation models based on the comparison; and
merging the new artificial intelligence generation model with the similar artificial intelligence generation model.

10. The method of claim 9, wherein the comparing of the first latent vector to the second latent vector comprises:
calculating a difference between the first latent vector and the second latent vector; and
calculating a similarity value based on the difference, wherein the similar artificial intelligence generation model is selected based on the similarity value.

11. A computing device comprising:
a memory storing model pool data corresponding to a plurality of artificial intelligence generation models; and
a processor configured to:
obtain original data representing one or more characteristics of a target object;
select an artificial intelligence generation model from among the plurality of artificial intelligence generation models based on the original data;
generate reconstructed data based on the original data using the artificial intelligence generation model;
calculate an anomaly score by comparing the original data and the reconstructed data; and
output detection result data indicating whether the target object is abnormal based on the anomaly score.

12. The computing device of claim 11, wherein the obtaining of the original data comprises:
receiving a data stream in real time and dividing the data stream into a plurality of batches, wherein the original data comprises a batch of the plurality of batches; and
wherein the processor is configured to further calculate a plurality of anomaly scores corresponding to the plurality of batches and generating distribution data including a distribution of the plurality of anomaly scores.

13. The computing device of claim 11, wherein the calculating of the anomaly score comprises:
encoding the original data using an encoder neural network of the artificial intelligence generation model to obtain encoded data;
decoding the encoded data using a decoder neural network of the artificial intelligence generation model to obtain reconstructed data; and
computing a difference between the reconstructed data and the original data.

14. The computing device of claim 11, wherein the selecting of the artificial intelligence generation model comprises:
calculating a first anomaly score based on previously received data;
calculating a second anomaly score based on the original data using the artificial intelligence generation model; and
calculating a first reliability value representing a compatibility between the original data and the artificial intelligence generation model based on the first anomaly score and the second anomaly score, wherein the artificial intelligence generation model is selected based at least in part on the first reliability value.

15. The computing device of claim 14, wherein the calculating of the first reliability value comprises:
comparing the first anomaly score and the second anomaly score.

16. The computing device of claim 14, wherein the selecting of the artificial intelligence generation model further comprises:
determining that the first reliability value is greater than a first reference value.

17. The computing device of claim 14, wherein the selecting of the artificial intelligence generation model further comprises:
calculating a third anomaly score based on the original data using another artificial intelligence generation model; and
calculating a second reliability value representing a compatibility between the original data and the another artificial intelligence generation model based on the first anomaly score and the third anomaly score, wherein the artificial intelligence generation model is selected based at least in part on the second reliability value.

18. The computing device of claim 16, wherein the selecting of the artificial intelligence generation model comprises:
calculating a first anomaly score based on previously received data using each of the plurality of artificial intelligence generation models;
calculating a second anomaly score based on the original data using each of the plurality of artificial intelligence generation models;
calculating a reliability value corresponding to a compatibility between the original data and each of the plurality of artificial intelligence generation models, respectively, based on the first anomaly score and the second anomaly score; and
updating a model pool including the plurality of artificial intelligence generation models based on the reliability value.

19. The computing device of claim 11, wherein the processor is further configured to:
train a new artificial intelligence generation model using the original data;
generate a first latent vector using the new artificial intelligence generation model;
generate a second latent vector using each of the plurality of artificial intelligence generation models;
compare the first latent vector to the second latent vector for each of the plurality of artificial intelligence generation models, respectively;
select a similar artificial intelligence generation model from the plurality of artificial intelligence generation models based on the comparison; and
merge the new artificial intelligence generation model with the similar artificial intelligence generation model.

20. (canceled)

21. A system comprising:
measurement equipment configured to generate original data including multidimensional vectors corresponding to characteristics of a target object; and
a server configured to receive the original data, to calculate an anomaly score corresponding to a degree of reconstruction between the original data and reconstructed data of the original data by using an artificial intelligence generation model compatible with the original data among a plurality of artificial intelligence generation models, and to output detection result data indicating whether the target object is abnormal, based on the anomaly score and a reference score.
